(19) United States
(12) Patent Application Publication
(10) Pub. No.: US 2018/0143955 A1
(43) Pub. Date: May 24, 2018

(54) CO-AUTHORING ON DOCUMENTS SAVED TO NON-CLOUD LOCATIONS

(71) Applicant: Microsoft Technology Licensing, LLC, Redmond, WA (US)

(72) Inventors: Matthew Bryan Jeffries, Sammamish, WA (US); Varagur Karthikeyan Sriram Iyer, Sammamish, WA (US); Rorke Haining, Kirkland, WA (US); Michael Paer, Seattle, WA (US)

(73) Assignee: Microsoft Technology Licensing, LLC, Redmond, WA (US)

(21) Appl. No.: 15/382,312

(22) Filed: Dec. 16, 2016

Related U.S. Application Data
(60) Provisional application No. 62/424,099, filed on Nov. 18, 2016.

(51) Int. Cl. G06F 17/22; G06F 17/24; G06F 3/0484; H04L 29/06

(52) U.S. Cl. CPC G06F 17/2288; G06F 17/24; H04L 65/4015; G06F 17/2235; G06F 3/0484; G06F 17/2205

(57) ABSTRACT

Providing automatic updates to transmitted copies of an electronic document is disclosed herein. In response to the first user such as the author/first user saving the electronic document, a copy of the electronic document is uploaded to a shared location and a reference to the copy of the electronic document uploaded to the shared location is stored in metadata of the electronic document. The first user can then transmit a copy of the electronic document with a link to the reference in the metadata to a second user. Then, if the first user subsequently revises the electronic document, the revised electronic document is uploaded to the shared location. When the second user then opens the copy of the electronic document, a copy of the most recently revised electronic document is retrieved from the shared location.

### RELATED APPLICATIONS

This application claims priority from U.S. Provisional Patent Application No. 62/424,099 titled, “CO-AUTHORING ON DOCUMENTS SAVED TO NON-CLOUD LOCATIONS” and having a filing date of Nov. 18, 2016, which is incorporated herein by reference.

### BACKGROUND

Users are able to share electronic documents with other users more easily because computing devices and connectivity have become almost ubiquitous. These users may collaborate on electronic documents by sharing edits with one another. However, it is difficult to collaborate on some documents when a user is not aware of another user's edits.

Today, for example, in order to share an electronic document with others so that you can see another user's changes, a copy of the electronic document may be sent in a message as an attachment or may be saved on a removable memory stick that is provided to the other user. The user can then open the attachment from the email or from the removable memory stick. However, this is commonly referred to as dead sharing because the copy of the shared document is not connected anywhere, which precludes two or more users from accessing the document simultaneously in real time.

In another example, the electronic document is saved to a cloud location and a link to that electronic document is sent to the user that you want to collaborate with. Sharing the electronic document in this manner is commonly referred to as live sharing, because two or more users may access the document simultaneously in real time.

When a dead document is edited by another user, you will not be able to see those edits in real time. The other user will have to make another copy of the electronic document and send it back via email, the memory stick, or by some other means. Moreover, after you have sent a dead electronic document to another user, any subsequent changes you make to the electronic document will not be seen by the other user unless those changes are separately sent to the other user. What is needed is an improved system and method for collaborating on dead documents such as those saved to non-cloud locations.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

To improve collaboration on shared documents among users when creating, editing or revising the documents, the systems, methods, and computer storage media disclosed herein provide automatic updates to transmitted copies of an electronic document upon opening the transmitted copies of the electronic document by others and in response to revisions by the author of the electronic document.

According to one aspect disclosed herein, a computer-implemented method is presented for improving collaboration on electronic documents. The method disclosed herein includes saving an electronic document by a first user. In response to the first user saving the electronic document, the method includes automatically uploading a copy of the electronic document to a shared location and storing a reference to the copy of the electronic document uploaded to the shared location in metadata of the electronic document saved by the first user. The method then includes transmitting by the first user a copy of the electronic document with the reference in the metadata to a second user. If the first user subsequently revises the electronic document, a copy of the revised document is uploaded to the shared location. The method then includes opening the copy of the electronic document transmitted to the second user and, in response to opening the copy of the electronic document transmitted to the second user, the method includes replacing the copy of the electronic document transmitted to the second user with a copy of the revised electronic document retrieved from the shared location. The method may also include the second user revising the copy of the electronic document transmitted from the first user, uploading a copy of the electronic document revised by the second user to the shared location, and replacing the first user's electronic document with the copy of the electronic document revised by the second user from the shared location in response to opening the electronic document saved by the first user. Also, the method may include the second user transmitting the copy of the electronic document to one or more other users, such as a third user, and automatically replacing the copy of the electronic document transmitted to the third user with the revised electronic document retrieved from the shared location in response to the third user opening the copy of the electronic document transmitted by the second user.

According to another aspect disclosed herein, a collaboration system for improving collaboration on shared electronic documents is provided. The system includes a processor and memory, including instructions, which when executed by the processor are operable to provide an electronic document collaboration system. The electronic document collaboration system includes a word processor for creating, revising, and storing electronic documents, wherein an electronic document is saved by a first user. In response to the first user saving the electronic document, a copy of the electronic document is automatically uploaded to a shared location and a reference to the copy of the electronic document uploaded to the shared location is stored in metadata of the electronic document saved by the first user. Also, the collaboration system includes a messaging application for exchanging electronic messages between users, wherein a copy of the electronic document is transmitted by the first user with the reference in the metadata to a second user. Where the electronic document is subsequently revised by the first user the system is further operative to upload a copy of the revised electronic document to the shared location. When the copy of the electronic document transmitted to the second user is opened, the system is further operative to update or replace the copy of the electronic document transmitted to the second user with a copy of the revised electronic document retrieved from the shared location.

According to yet another aspect disclosed herein, a computer readable storage device including instructions is provided. The instructions, when executed by a processor, are operable to perform saving an electronic document by a first user to non-cloud storage and, in response to the first user saving the electronic document, automatically uploading a copy of the electronic document to cloud storage and inserting a link in the electronic document to an identifier stored in metadata of the copy of the electronic document uploaded to the cloud storage. The instructions also operable to perform transmitting by the first user a copy of the electronic document with the reference in the metadata to a second user, revising the electronic document by the first user and uploading the revised electronic document to the cloud storage, and opening the copy of the electronic document transmitted to the second user. In response to opening the copy of the electronic document transmitted to the second user, the instructions are operable to perform replacing of the copy of the electronic document transmitted to the second user with a copy of the revised electronic document retrieved from the cloud storage.

Examples are implemented as a computer process, a computing system, or as an article of manufacture such as a device, computer program product, or computer readable medium. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is an illustration showing components of an example electronic document collaboration system and environment in which users are connected to available cloud storage and resources;

FIG. 2A illustrates example metadata of a shared electronic document according to at least one aspect herein;

FIG. 2B illustrates the metadata associated with the collaboration of the shared electronic document when uploaded to a shared location according to at least one aspect herein;

FIG. 2C illustrates the metadata associated with the collaboration of the shared electronic document when transmitted to a second location according to at least one aspect herein;

FIG. 3 illustrates a flowchart showing general stages involved in an example method for collaborating on shared electronic documents according to at least one aspect herein;

FIG. 4 illustrates optional stages to the flowchart of FIG. 3 according to one or more aspects disclosed herein;

FIG. 5 is a block diagram illustrating example physical components of a computing device;

FIGS. 6A and 6B are block diagrams of a mobile computing device; and

FIG. 7 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

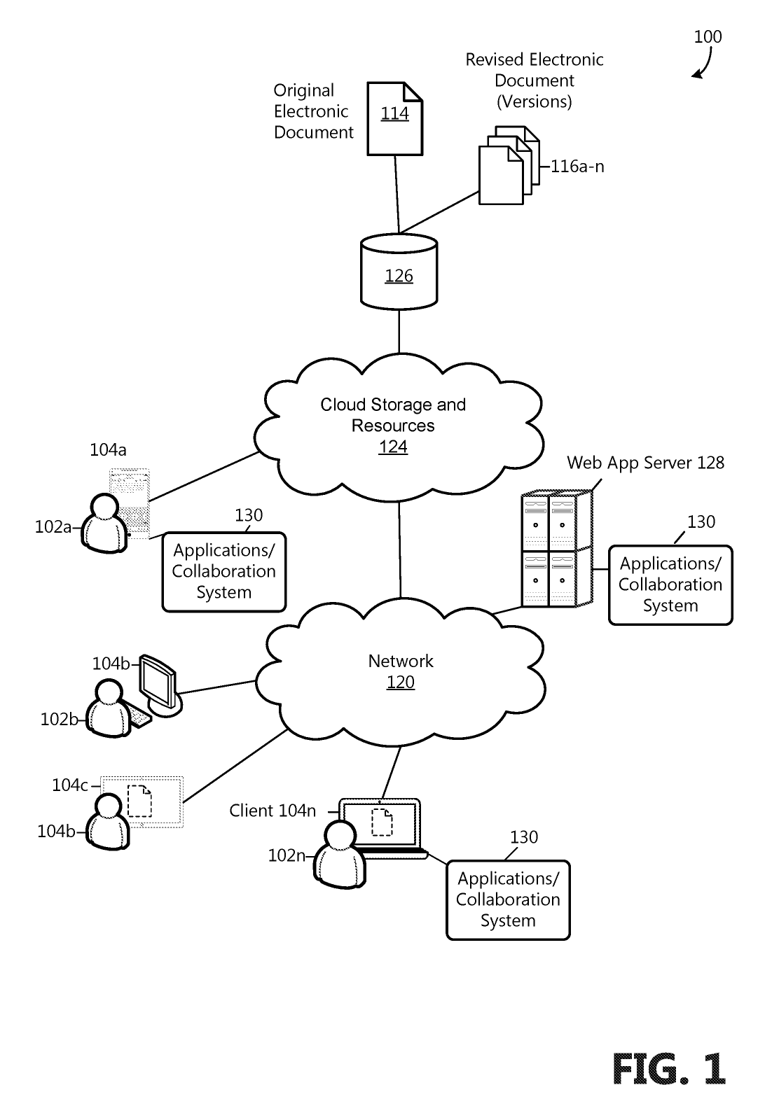

Aspects of the present disclosure are directed to a method, system, and computer storage device for facilitating electronic document collaboration. In particular, the present disclosure facilitates co-authoring and collaboration on electronic documents which may be saved to non-cloud locations. FIG. 1 illustrates an example environment 100 facilitating co-authoring on electronic documents 114 such as those saved to non-cloud locations. The environment 100 includes at least one client computing device 104a-n (collectively, 104), utilized by users 102a-n (collectively 102), in the form of a desktop computer, laptop computer, tablet computer, handheld computing device, mobile communication device, wearable device, gaming device, and the like. One or more client computing devices 104 may be connected to one another via a network 120 such as an enterprise network or the Internet. The computing devices 104 may be connected to a shared location such as cloud storage and resources 124 via the network 120. Client computing devices 104 may instead directly communicate with the cloud storage 124 without the network 120.

As illustrated, the cloud storage 124 includes a storage repository 126 at which the one or more electronic documents 114, 116 may be stored. According to examples, the storage repository 126 is operative to store revised versions of the electronic documents 114 (116) as explained in greater detail below. Clients 102 are able to directly access the electronic documents 114, 116 in the storage repository 126 of the cloud storage 124 or may instead access the electronic documents 114, 116 in the storage repository 126 of the cloud storage 124 via the network 120. Client users 102 are able to generate, edit, revise or otherwise interact with the electronic documents 114, 116.

Examples of suitable applications 130 include, but are not limited to: word processing, spreadsheet, database, slide presentation, electronic mail, drawing, web browser, media player, and game applications. In some examples, the application(s) 130 are web applications run on a web application server 128 of the cloud storage 124 and communicate with a user agent, such as a browser, via the network 120. The user agent may provide a user interface that allows a user 102 to interact with application content and electronic documents 114 stored in the storage repository 126. The user interface is displayed on a display of the client device 104 running the user agent. In some aspects, the user agent is a dedicated client application that provides a user interface and access to electronic documents 114 and the revised electronic document versions 116 in the storage repository 126. In other examples, the application(s) 130 are local applications 130 stored and executed on the client device 104 and provide a user interface that allows a user 102 to interact with application content, electronic documents 114, and the revised electronic document versions 116 stored in the storage repository 126. The collaboration system which includes the functionality described herein may be embodied within one or more of the applications 130. Therefore, the electronic document collaboration system as well as one or more of the applications may each be individually referred to, or be collectively referred to, by the reference number 130.

In one or more aspects, the author of a new electronic document 114 or a user 102 of an existing electronic document 114 that is being edited or revised may save the electronic document 114. In the context of the present disclosure, it makes no difference whether the electronic document 114 is saved to non-cloud or cloud storage. The electronic document 114 may be saved wherever the user chooses. However, in response to the author/first user 102a saving the electronic document 114, a copy of the electronic document 114 (original electronic document 114) is uploaded to a shared location such as the cloud storage 124. In one or more aspects, the electronic document 114 is uploaded unbeknownst to the author/first user 102a. Also, a reference to the copy of the electronic document 114 uploaded to the cloud storage 124 is stored within the metadata of the electronic document 114 saved by the author/first user 102a.

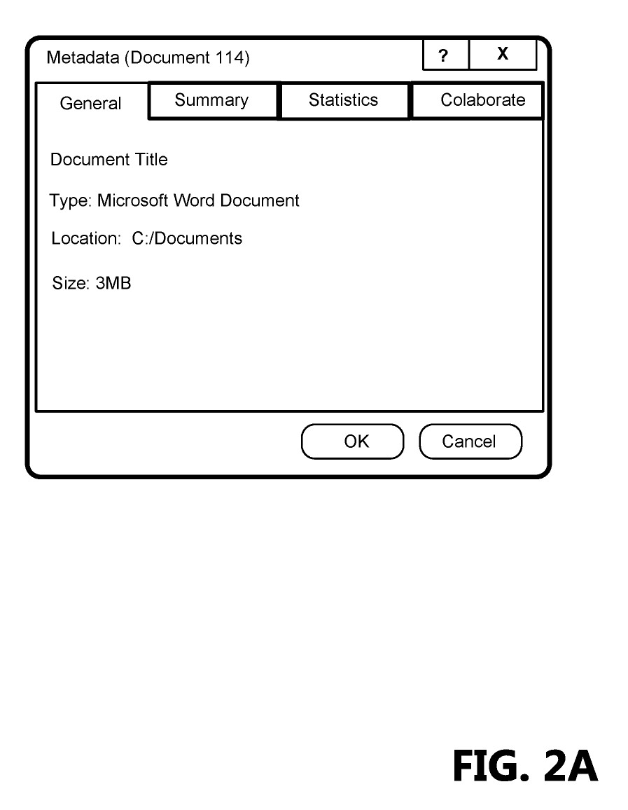

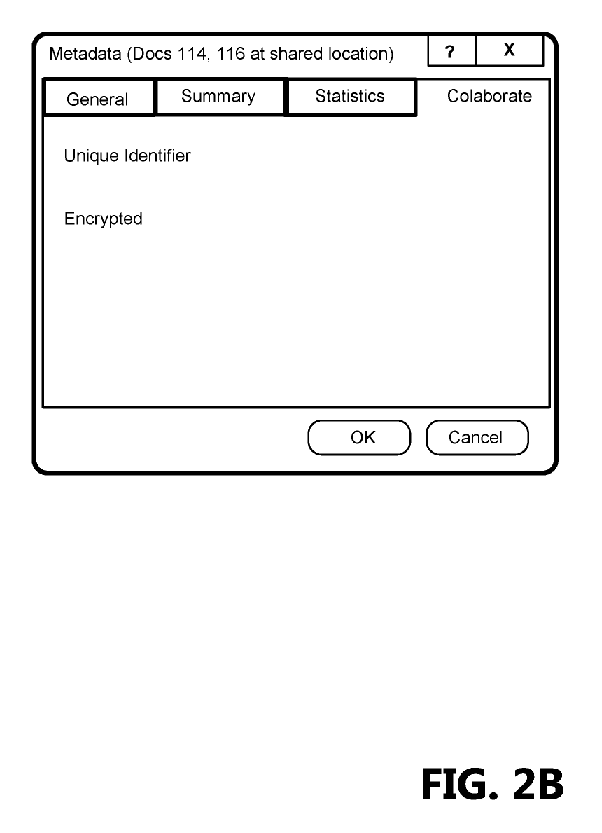

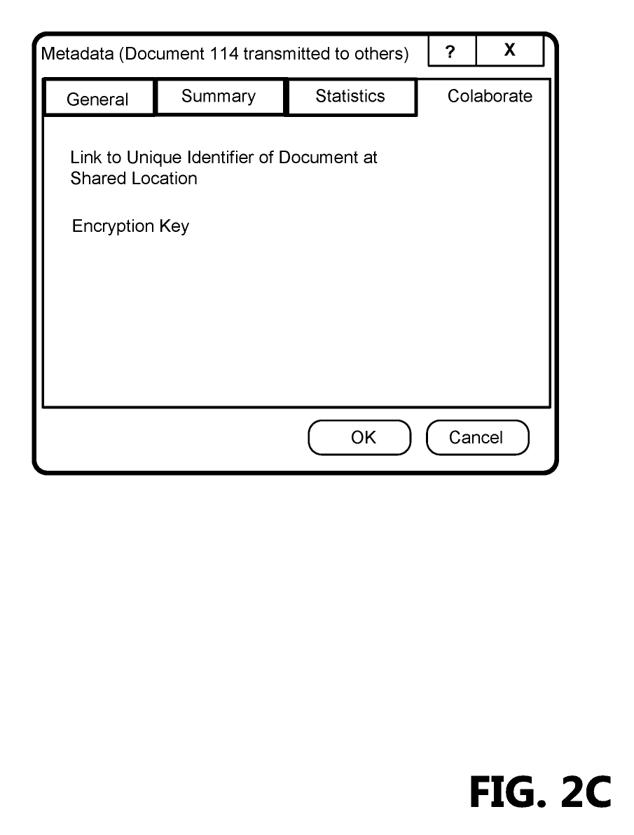

FIGS. 2A-C illustrate example metadata associated with different copies of the electronic document 114, 116. FIG. 2A is example metadata of a shared electronic document 114 according to at least one aspect. As explained herein, when an electronic document 114 is saved, a copy of the electronic document 114 is uploaded to the cloud storage 124. Prior to uploading, the metadata of the electronic document 114 are customized for the purposes of collaboration to include an identifier as shown in FIG. 2B. In the event the user subsequently revises the electronic document 114, a copy of the revised electronic document 116 is uploaded to the cloud storage 124 with the metadata having the identifier. The identifier may be referred to as a unique identifier that is generated randomly according to implementations pursuant to the universally unique identifier (UUID) standard. In one or more other examples, where the electronic document 114 is saved to cloud storage 124 and accessible via a link, the cloud server itself could provide encryption and access control rather than including the encryption key in the metadata of the electronic document 114. FIG. 2C illustrates the customized metadata associated with the copy of the shared electronic document 114 transmitted by the author/first user 102a to another user 102 according to at least one aspect. As shown FIG. 2C, the metadata are customized to include a link to the identifier saved in the metadata of the electronic documents 114, 116 uploaded to the cloud storage 124.

As referenced above, after the electronic document 114 and the associated metadata are transmitted to the second user 102b, the author/first user 102a may revise the electronic document 114 which had been saved by the author/first user 102a. In such case, a copy of the revised electronic document 116 is uploaded to cloud storage 124. When the second user 102b opens the copy of the electronic document 114 transmitted by the author/first user 102a, all or part of it is replaced or updated by all or part of a copy of the revised electronic document 116 retrieved from the cloud storage 124. For example, an entire copy of the revised electronic document 116 can be retrieved to replace an entire copy of the electronic document 114 transmitted to the second user 102b. In one or more other aspects, only a portion of the revised electronic document 116, such as the changes entered by the author/first user 102a, is retrieved to update or replace only a portion of the electronic document 114 transmitted to the second user. In either case, the electronic document 114 that the second user 102b interacts with will then match the author's/first user's revised electronic document 116.

In one or more aspects, replacing the copy of the electronic document 114 with a copy of the revised electronic document 116 retrieved from cloud storage 124 is performed unbeknownst to the second user 102b. Alternatively, the second user 102b may be provided with the option to replace all or part of the copy of the electronic document 114 transmitted from the first user 102a with all or part of a copy of the revised electronic document 116 from the shared location.

In one or more other aspects, the second user 102b may save the copy of the revised electronic document 116 received from the shared location in order to retain the copy of the revised electronic document 116. Otherwise, even though a copy of the revised electronic document 116 replaced the copy of the electronic document 114 transmitted from the first user 102a, the copy of the electronic document 114 transmitted from the first user 102a will appear the next time the second user 102b opens the electronic document 114 because the copy of the revised electronic document 116 was not saved by the second user 102b. Thus, in one or more aspects, the second user 102b may decline to save the copy of the revised electronic document 116 received from the shared location in order to revert to the copy of the electronic document 114 transmitted from the first user 102a.

The customized metadata of the electronic document 114 may also include an encryption key as shown in FIG. 2C. The copy of the electronic document 114 uploaded to the cloud storage 124 may be encrypted. For purposes of decryption, the encryption key is stored in the metadata of the copy of the electronic document 114 transmitted to other users 102, such as the second user 102b. The electronic document 114 may, for example, be transmitted as an attachment to an electronic message such as an email or transmitted via removable storage such as a memory stick. Upon opening the copy of the electronic document 114 that had been transmitted to the second user 102b and in order to replace the copy of the electronic document 114 that had been transmitted to the second user 102b with the encrypted copy of the revised electronic document 116 at the cloud storage 124, the encryption key is used to decrypt the encrypted copy of the revised electronic document 116 retrieved from the cloud storage 124.

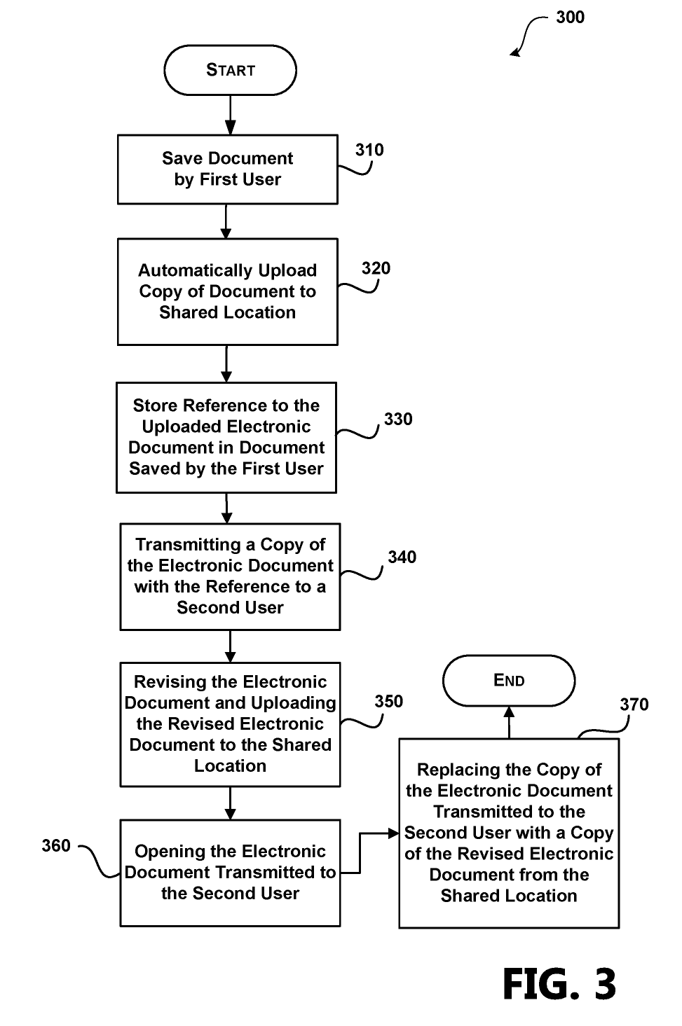

Turning now to FIG. 3, a flowchart is shown depicting the general stages involved in an example method 300 for collaborating on shared electronic documents according to at least one aspect. The method 300 begins at START and proceeds to OPERATION 310 where an author/first user 102a saves an electronic document 114. The electronic document 114 may be saved anywhere such as, but not limited to, a USB memory stick, hard drive, or an email attachment. In response to saving the electronic document 114, a copy of the electronic document 114 is uploaded to a shared location such as the cloud storage 124 as shown in OPERATION 320. Also, as shown in OPERATION 330, in response to saving the electronic document 114, a reference to the copy of the electronic document 114 uploaded to the cloud storage 124 is stored in metadata of the electronic document 114 saved by the first user 102a. In one or more aspects, storing a reference to the copy of the electronic document 114 at the shared location 124 includes inserting a link in the electronic document 114 to an identifier in the copy of the electronic document 114, 116 stored at the shared location. Also, upon detecting the link in the metadata of the copy of the electronic document 114 transmitted to the second user 102b, it is possible to determine whether the shared location includes a revised copy of the electronic document such as the revised electronic document 116. For example, when a word processing application such as Microsoft WORD™ opens and renders a document, an additional software utility may be added to the word processing application. In one example, an add-in may be loaded in a side pane of WORD™ that checks for the metadata in the document. In another example, the word processing application itself could be updated rather than use the add-in. If there are metadata, the add-in can determine how revisions are stored at the shared location. For example, if there is a link in the metadata, the link refers to the unique identifier in the metadata in the copy of the revised electronic document 116 in the cloud storage 124.

The method 300 then proceeds to OPERATION 340 for transmitting by the first user 102a a copy of the electronic document 114 with the reference in the metadata to a second user 102b and to OPERATION 350 which includes the first user 102a revising the electronic document 114 and then uploading the revised electronic document 116 to the shared location. Then, the method 300 proceeds to OPERATION 360 for opening the electronic document 114 transmitted to the second user 102b. In response to the second user opening the electronic document 114, the method 300 proceeds to OPERATION 370 for replacing all or part of the copy of the electronic document 114 transmitted to the second user 102b with all or part of a copy of the revised electronic document 116 retrieved from the shared location. From OPERATION 370 the method then concludes at END.

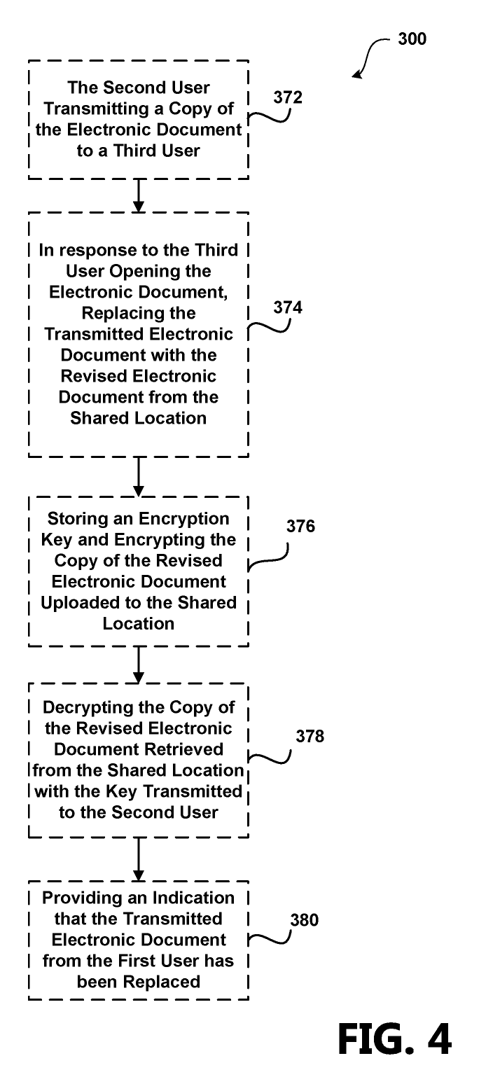

The method 300 may also include one or more of the optional operations as shown in FIG. 4. The method 300 may also include OPERATION 372 for the second user 102b transmitting the copy of the electronic document 114 to a third user 102c. In such case, the method 300 then proceeds to OPERATION 374 for automatically replacing the copy of the electronic document 114 transmitted to the third user 102c with the revised electronic document 116 (revised by the first user 102a) retrieved from the shared location in response to the third user 102c opening the copy of the electronic document 114 transmitted by the second user 102b. The method 300 may also include the second user 102b revising the copy of the electronic document 114 transmitted from the first user 102a, uploading a copy of the electronic document 114 revised by the second user 102b to the shared location, and replacing the first user's electronic document 114 with the copy of the revised electronic document 116, revised by the second user 102b, retrieved from the shared location in response to the first user 102a opening the electronic document 114 that had been saved by the first user 102a.

Still referring to FIG. 4, the method 300 may also include OPERATION 376 for generating and storing an encryption key in the metadata of the electronic document 114 and encrypting the revised copy of the electronic document 116 uploaded to the shared location. Then, the method 300 proceeds to OPERATION 378 for decrypting the copy of the revised document 116 retrieved from the shared location with the encryption key in order to replace the copy of the electronic document 114 transmitted to the second user 102b. In one or more aspects, the method 300 may include OPERATION 380 for providing an indication to the second user 102b that the copy of the electronic document 114 transmitted from the first user 102a has been replaced by the copy of the revised electronic document 116 from the shared location.

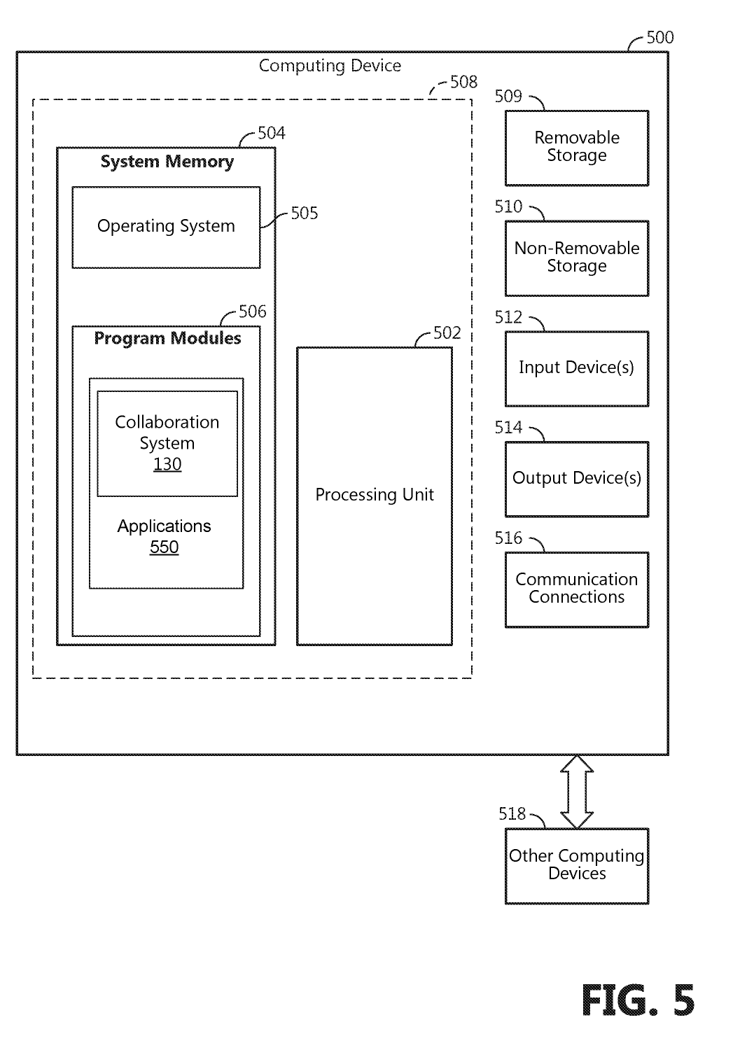

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are utilized for practicing aspects, described herein.

FIG. 5 is a block diagram illustrating physical components (i.e., hardware) of a computing device 500 with which examples of the present disclosure are be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes the collaboration system 130. The operating system 505, for example, is suitable for controlling the operation of the computing device 500. Furthermore, aspects are practiced in conjunction with a graphics library, other operating systems, or any other application program, and are not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., collaboration system 130) perform processes including, but not limited to, one or more of the stages of the method 300 illustrated in FIGS. 3 and 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 5 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 500 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media is part of the computing device 500. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

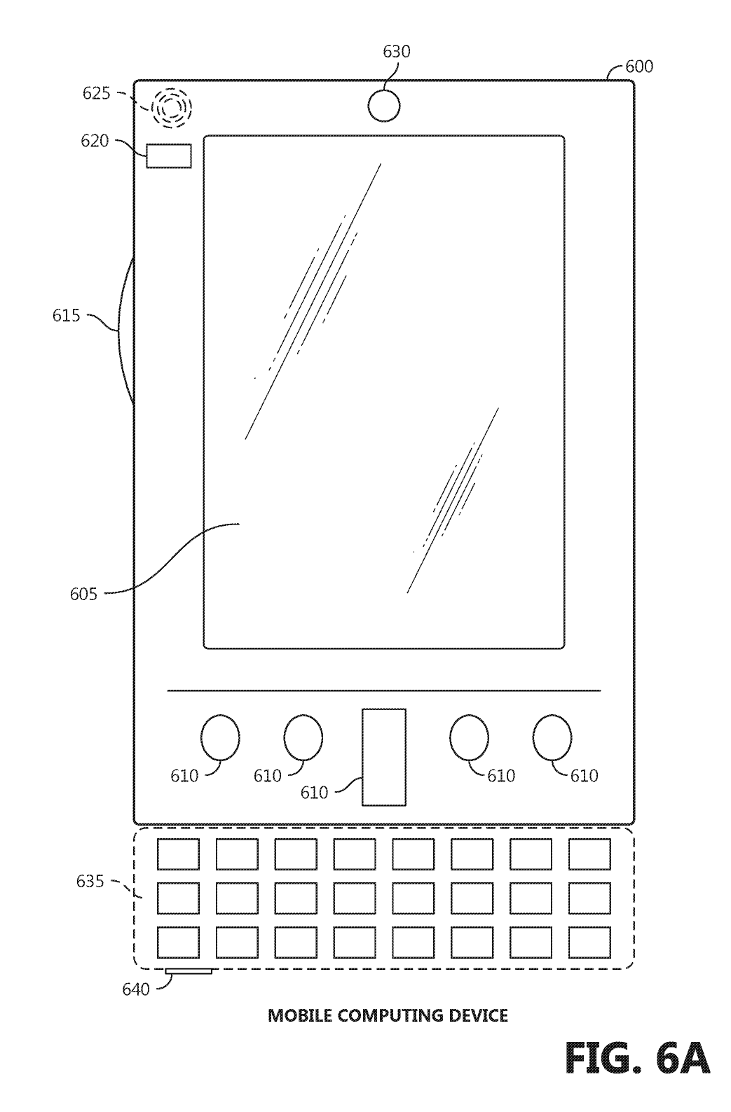

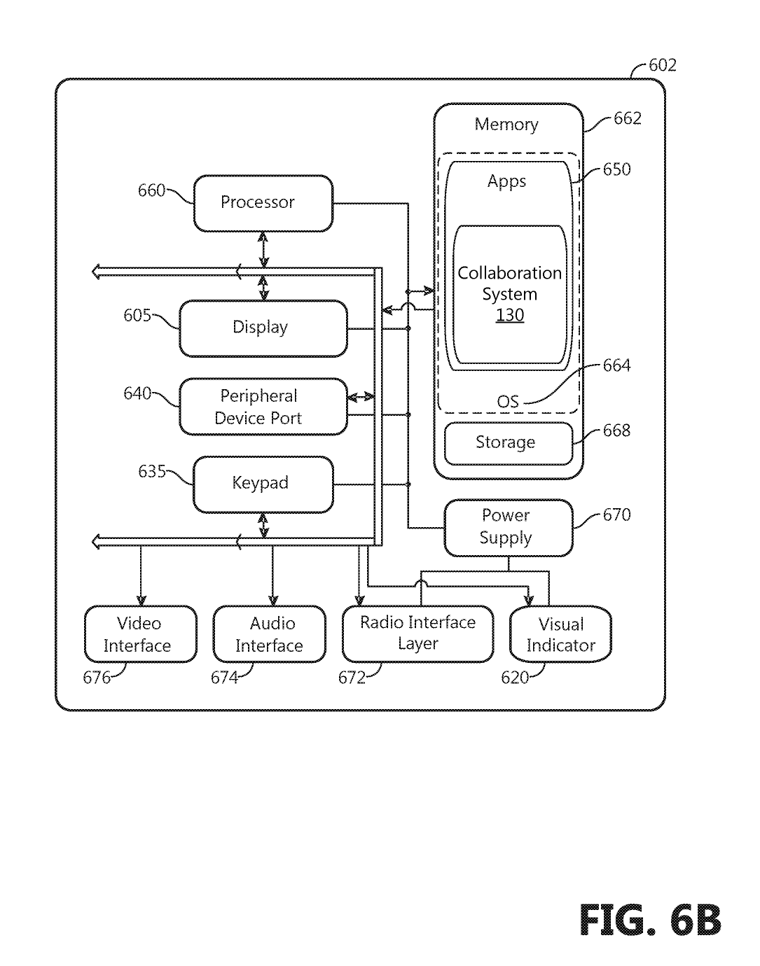

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or less input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, the collaboration system 130 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 is stored locally on the mobile computing device 600, as described above. According to another aspect, the data is stored on any number of storage media that is accessible by the device via the radio 672 or via a wired connection between the mobile computing device 600 and a separate computing device associated with the mobile computing device 600, for example, a server computer in a distributed computing network, such as the Internet. As should be appreciated such data/information is accessible via the mobile computing device 600 via the radio 672 or via a distributed computing network. Similarly, according to an aspect, such data/information is readily transferred between computing devices for storage and use according to well-known data/information transfer and storage means, including electronic mail and collaborative data/information sharing systems.

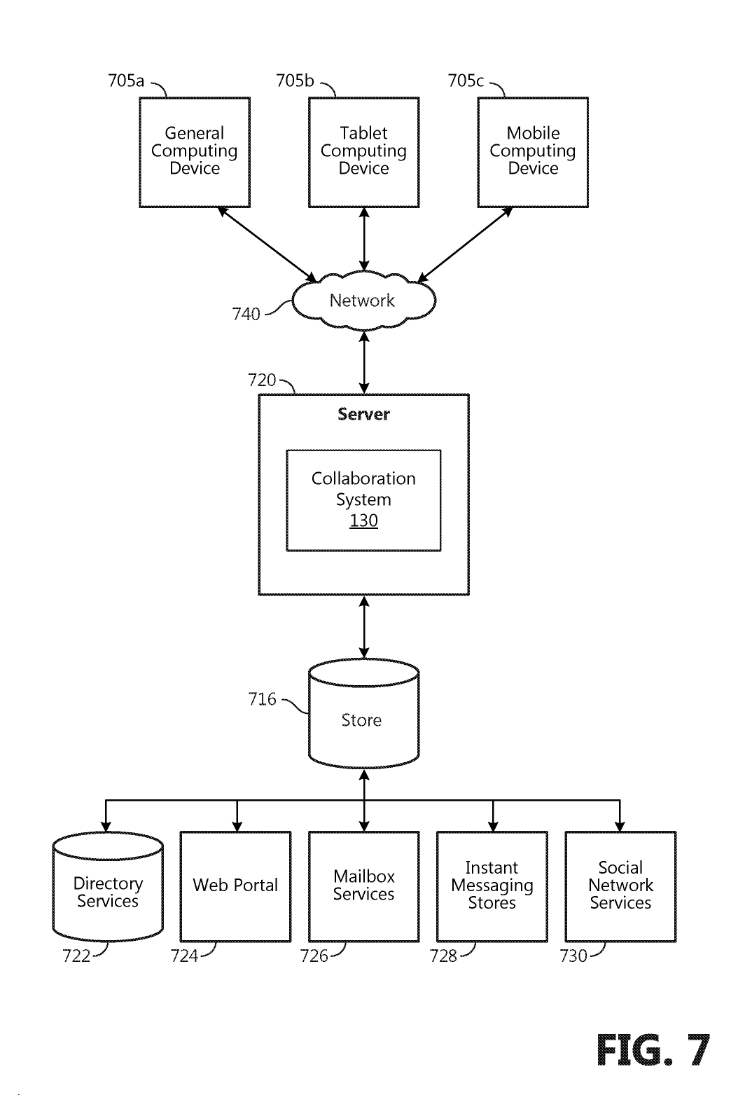

FIG. 7 illustrates one example of the architecture of a system for memory conserving versioning of an electronic document 114 as described above. Content developed, interacted with, or edited in association with the collaboration system 130 is enabled to be stored in different communication channels or other storage types. For example, various documents may be stored using a directory service 722, a web portal 724, a mailbox service 726, an instant messaging store 728, or a social networking site 730. The collaboration system 130 is operative to use any of these types of systems or the like for memory conserving versioning of an electronic document 114, as described herein. According to an aspect, a server 720 provides the collaboration system 130 to clients 705a,b,c. As one example, the server 720 is a web server providing the collaboration system 130 over the web. The server 720 provides the client collaboration system 130 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for collaborating on electronic documents, comprising:
saving an electronic document by a first user;
in response to the first user saving the electronic document, automatically uploading a copy of the electronic document to a shared location and storing a reference to the copy of the electronic document uploaded to the shared location in metadata of the electronic document saved by the first user;
transmitting by the first user a copy of the electronic document with the reference in the metadata to a second user;
revising the electronic document by the first user and uploading the revised electronic document to the shared location;
opening the copy of the electronic document transmitted to the second user; and
in response to opening the copy of the electronic document transmitted to the second user, update the electronic document transmitted to the second user with a copy of the revised electronic document retrieved from the shared location.

2. The computer-implemented method of claim 1, wherein storing a reference to the copy of the electronic document at the shared location comprises inserting a link in the copy of the electronic document transmitted to the second user to an identifier in the copy of the electronic document stored at the shared location.

3. The computer-implemented method of claim 1, further comprising detecting a link in the metadata of the copy of the electronic document transmitted to the second user and determining whether the shared location includes the revised electronic document.

4. The computer-implemented method of claim 1, further comprising the second user transmitting a copy of the electronic document to a third user and automatically replacing the copy of the electronic document transmitted to the third user with the revised electronic document retrieved from the shared location in response to the third user opening the copy of the electronic document transmitted by the second user.

5. The computer-implemented method of claim 1, further comprising the second user revising the copy of the electronic document transmitted from the first user, uploading a copy of the electronic document revised by the second user to the shared location, and replacing the first user's electronic document with the copy of the electronic document revised by the second user from the shared location in response to the first user opening the electronic document that had been saved by the first user.

6. The computer-implemented method of claim 1, further comprising generating and storing an encryption key in the metadata of the copy of the electronic document, encrypting the revised copy of the electronic document uploaded to the shared location, and decrypting the copy of the revised document retrieved from the shared location with the encryption key in order to update the copy of the electronic document transmitted to the second user.

7. The computer-implemented method of claim 1, wherein the copy of the electronic message transmitted to the second user is transmitted via a memory stick.

8. The computer-implemented method of claim 1, wherein automatically uploading a copy of the electronic document to a shared location comprises automatically uploading the copy of the electronic document to cloud storage.

9. The computer-implemented method of claim 1, wherein saving an electronic document by a first user comprises one of:
saving the electronic document to non-cloud storage; and
saving the electronic document to cloud storage.

10. The computer-implemented method of claim 1, wherein automatically uploading a copy of the electronic document to a shared location is performed automatically unbeknownst to the first user.

11. The computer-implemented method of claim 1, wherein replacing the copy of the electronic document transmitted to the second user with a copy of the revised electronic document retrieved from the shared location is performed automatically unbeknownst to the second user.

12. The computer-implemented method of claim 1, further comprising providing an indication to the second user that the copy of the electronic document transmitted from the first user has been replaced by the revised copy of the electronic document from the shared location.

13. The computer-implemented method of claim 1, further comprising the second user saving the copy of the revised electronic document received from the shared location in order to retain the copy of the revised electronic document.

14. The computer-implemented method of claim 1, further comprising the second user declining to save the copy of the revised electronic document received from the shared location in order to revert to the copy of the electronic document transmitted from the first user.

15. A collaboration system for collaborating on electronic documents, comprising:
at least one processor; and
a memory, including instructions, which when executed by the processor are operable to provide an electronic document collaboration system, the electronic document collaboration system comprising:
a word processor for creating, revising and storing electronic documents, wherein an electronic document is saved by a first user, wherein in response to the first user saving the electronic document, a copy of the electronic document is automatically uploaded to a shared location and a reference to the copy of the electronic document uploaded to the shared location is stored in metadata of the electronic document saved by the first user; and
a messaging application for exchanging electronic messages between users, wherein a copy of the electronic document is transmitted by the first user with the reference in the metadata to a second user, wherein the electronic document is subsequently revised by the first user and a copy of the revised electronic document is uploaded to the shared location, and wherein in response to opening the copy of the electronic document transmitted to the second user the copy of the electronic document transmitted to the second user is replaced with a copy of the revised electronic document retrieved from the shared location.

16. The collaboration system of claim 15, wherein storing a reference to the copy of the electronic document at the shared location comprises inserting a link in the electronic document to an identifier in the copy of the electronic document stored at the shared location.

17. The collaboration system of claim 15, further comprising the second user transmitting the copy of the electronic document to a third user and automatically update the copy of the electronic document transmitted to the third user with the revised electronic document retrieved from the shared location in response to the third user opening the copy of the electronic document transmitted by the second user.

18. The collaboration system of claim 15, further comprising the second user revising the copy of the electronic document transmitted from the first user, uploading a copy of the electronic document revised by the second user to the shared location, and replacing the first user's electronic document with the copy of the electronic document revised by the second user from the shared location in response to the first user opening the electronic document that had been saved by the first user.

19. The collaboration system of claim 15, wherein the copy of the electronic message transmitted to the second user is transmitted as an attachment to an electronic message, the copy of the electronic document is automatically uploaded to the shared location unbeknownst to the first user, and the copy of the electronic document transmitted to the second user is automatically updated with a copy of the revised electronic document retrieved from the shared location unbeknownst to the second user.

20. A computer readable storage device including instructions, which when executed by a processor are operable to perform the steps comprising:
saving an electronic document by a first user to non-cloud storage;
in response to the first user saving the electronic document, automatically uploading a copy of the electronic document to a cloud storage and inserting a link in the electronic document to an identifier stored in metadata of the copy of the electronic document uploaded to the cloud storage;
transmitting by the first user a copy of the electronic document with the reference in the metadata to a second user;
revising the electronic document by the first user and uploading the revised electronic document to the cloud storage;
opening the copy of the electronic document transmitted to the second user; and
in response to opening the copy of the electronic document transmitted to the second user, replacing the copy of the electronic document transmitted to the second user with a copy of the revised electronic document retrieved from the cloud storage.
